(19) United States
(12) Patent Application Publication
(10) Pub. No.: US 2016/0086044 A1
(43) Pub. Date: Mar. 24, 2016

(54) Optical Device and Optical Scanning Method Thereof

(71) Applicant: AU Optronics Corporation, Hsin-Chu (TW)

(72) Inventors: Chia-Wei Yu, Hsin-Chu (TW); Tung-Tsun Lin, Hsin-Chu (TW); Yuan Mao, Hsin-Chu (TW); Chih-Ling Hsueh, Hsin-Chu (TW)

(21) Appl. No.: 14/494,827

(22) Filed: Sep. 24, 2014

(51) Int. Cl. G06K 9/20; G06K 9/00

(52) U.S. Cl. CPC G06K 9/209; G06K 9/0004; G06K 9/2009

(57) ABSTRACT

An optical device includes a substrate, a sensor layer, a light-filtering layer, and a control module. The sensor layer is disposed on the substrate and generates a pre-scan image. The light-filtering layer is disposed over the sensor layer, wherein the light-filtering layer allows or blocks external light from reaching the sensor layer. The control module is coupled to the sensor layer and the light-filtering layer, wherein the control module controls the light-filtering layer according to the pre-scan image to selectively allow or block external light.

### BACKGROUND

1. Technical Field

The present disclosure generally relates to an optical device; particularly, the present disclosure relates to an optical scanning device that has a structure for selectively allowing or blocking external light.

2. Description of the Related Art

In the continuing evolution of scanning technology and rapid adoption of scanning technologies in workplaces to improve work efficiency, manufacturers of scanning devices such as optical scanners are constantly looking to improve their products in the competitive market. In order to meet product needs, research and development have been trending towards applying optical scanners to displays to provide scanning and touch-sensitive capabilities. However, optical scanning has not traditionally been very reliable in procuring accurate scan images, such as fingerprint images.

In terms of the conventional optical scanning device 10, as seen in FIG. 1A, the optical scanning device 10 typically includes a sensor array A having a sensor unit S. Light from a backlight module disposed below the optical scanning device 10 may emit light through the optical scanning device 10, wherein the light is then bounced back into the optical scanning device 10 by a finger of an user touching the protection film P disposed on the sensor array A. The sensor unit S detects the light that is bounced back to form images. In this manner, the optical scanning device 10 may scan the user's finger and produce a corresponding fingerprint image. However, As seen in FIG. 1B, due to external light shining onto the optical scanning device 10 while the scan is being performed on the finger, portions E of the fingerprint image would not be very clear since the sensor unit S would be receiving excessive light. Therefore, a solution is needed for producing better and more accurate scan images in optical scan devices.

### SUMMARY

It is an object of the present disclosure to provide an optical device and an optical scanning method thereof that increase quality of image scans.

It is another object of the present disclosure to provide an optical device having a light-filtering layer that can be controlled to selectively allow or block external light to increase quality of image scans.

The optical device includes a substrate, a sensor layer, a light-filtering layer, and a control module. The sensor layer is disposed on the substrate and generates a pre-scan image. The light-filtering layer is disposed over the sensor layer and allows or blocks external light from reaching the sensor layer. The control module is coupled to the sensor layer and the light-filtering layer, wherein the control module controls the light-filtering layer according to the pre-scan image to selectively allow or block external light.

The optical scanning method for use in an optical device includes: (A) receiving in a control module a pre-scan image generated by a sensor layer; (B) receiving a scan instruction in the control module; and (C) accordingly to the scan instruction, controlling by the control module the light-filtering layer according to the pre-scan image to selectively allow or block external light.

### BRIEF DESCRIPTION OF THE DRAWINGS

FIG. 1A is a view of the conventional optical scanning device;

FIG. 1B is an image scan of the optical scanning device of FIG. 1A;

FIG. 2A is a view of an optical device of the present invention;

FIG. 2B is a view of the interaction within the optical device;

FIG. 2C is an image scan of the optical device of the present invention with improved image scanning quality;

FIG. 3A is a cross-sectional view of the display device of FIG. 2;

FIG. 3B is a circuit schematic diagram of the pixel electrode and sensor unit of the optical device of FIG. 3A;

FIG. 4A is another embodiment of the circuit schematic diagram of the pixel electrode and sensor unit of FIG. 3B;

FIG. 4B is a cross-sectional view of the optical device of FIG. 4A;

FIGS. 5A and 5B are another embodiment of the circuit schematic and optical device thereof;

FIG. 6A-7B are other different embodiments of the schematic diagram of the pixel electrode and sensor unit of the optical device;

FIG. 8A is another embodiment of FIG. 2 of the optical device with the light-filtering layer and the sensor layer on different substrates;

FIG. 8B is a cross-sectional view of the optical device of FIG. 8A; and

FIG. 9-11 are flowchart diagrams of the optical scanning method of the present invention.

### DETAILED DESCRIPTION OF THE PREFERRED EMBODIMENT

The present disclosure provides an optical device and an optical scanning method for use in the optical device. Preferably, the optical device is an optical scanning device that may be used in conjunction with display devices such as touch-sensitive displays; however, the optical device is not limited to being applied to touch-sensitive displays.

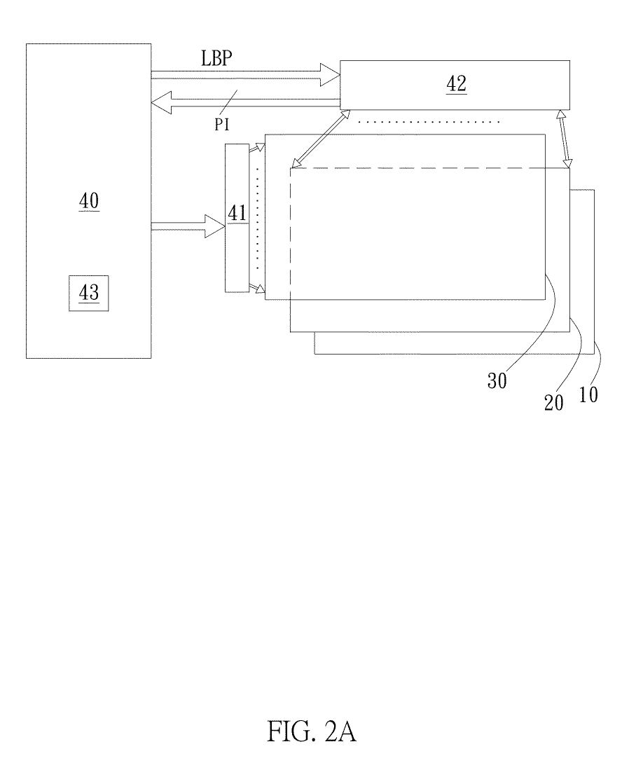

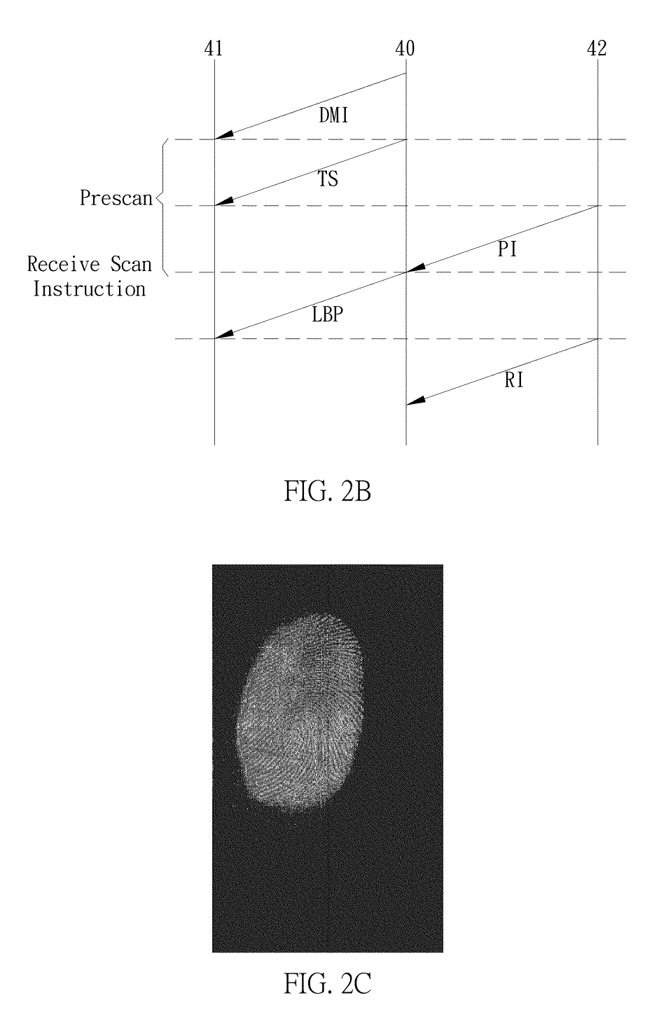

An embodiment of the optical device of the present invention is illustrated in FIG. 2A. As shown in FIG. 2A, the optical device 100 has a substrate 10, a sensor layer 20, a light-filtering layer 30, and a control module 40. The sensor layer 20 is disposed on the substrate 10. The light-filtering layer 30 is used to selectively allow or block external light from reaching the sensor layer 20. In this manner, the sensor layer 20 would not need to sense unnecessary light. In turn, the amount of noise data generated by the sensor layer 20 can also be effectively decreased. The light-filtering layer 30 may be implemented, for example, with liquid crystal molecules. However, in other different embodiments, the light-filtering layer 30 may be implemented in any other different method to filter light from reaching the sensor layer 20. In the present embodiment, the light-filtering layer 30 is disposed over the sensor layer 20, while the control module 40 is respectively coupled to the sensor layer 20 and the light-filtering layer 30. In the present embodiment, the control module 40 is coupled to the sensor layer 20 and the light-filtering layer 30 through a gate unit 41 and a data read-out-write-in unit 42. The gate unit 41 and the data read-out-write-in unit 42 may be implemented through various different types of driving circuits, such as chip-on-glass (COG), chip-on-film (COF), or any other types of driving circuits. The sensor layer 20 preferably has a plurality of sensor units or sensors to detect the light that passes through the light-filtering layer 30 and accordingly to the detected light generating signals to pass along to the data read-out-write-in unit 42. The data read-out-write-in unit 42, upon receiving the signals from the sensor layer 20, generates a pre-scan image PI. Preferably, in the present embodiment, the control module 40 is also connected to a storage unit 43 either internally or externally to store the pre-scan image PI generated by the data read-out-write-in unit 42. The storage unit 43 may include flash memory such as dynamic random access memory or any other type of storage memory to store the pre-scan image PI.

In the present embodiment, the pre-scan image PI is the most recent image data generated by the data read-out-write-in unit 42 from reading the signals outputted by the sensor layer 20. As shown in FIGS. 2A and 2B, in an embodiment, the control module 40 may transmit a default mode instruction DMI to the gate unit 41 in order to enable the gate unit 41 to set the light-filtering layer 30 to a default start mode. For example, the default start mode of the light-filtering layer 30 may be to allow all light to pass through. The control module 40 may then begin a prescan stage by transmitting a signal TS to the gate unit 41 to drive the sensor layer 20 in order for the sensor layer 20 to transmit the signals from the sensor units (signals forming the pre-scan image PI) to the data read-out-write-in unit 42. In this manner, the data read-out-write-in unit 42 can then subsequently transmit the pre-scan image PI to the control module 40.

In the present embodiment, the prescan stage may be repeated any number of times until the control module 40 receives a scan instruction. After receiving the scan instruction, the control module 40 will control the light-filtering layer 30 according to the most recent pre-scan image PI stored in the storage unit 43 to selectively allow or block external light. This scan instruction may be generated automatically by the optical device 100 from an user touching the screen of the optical device 100, or may be generated according to the user pressing a manual keypad on the optical device 100. However, the scan instruction may also be generated in other ways, such as being automatically generated by the control module 40 periodically according to a predetermined default time.

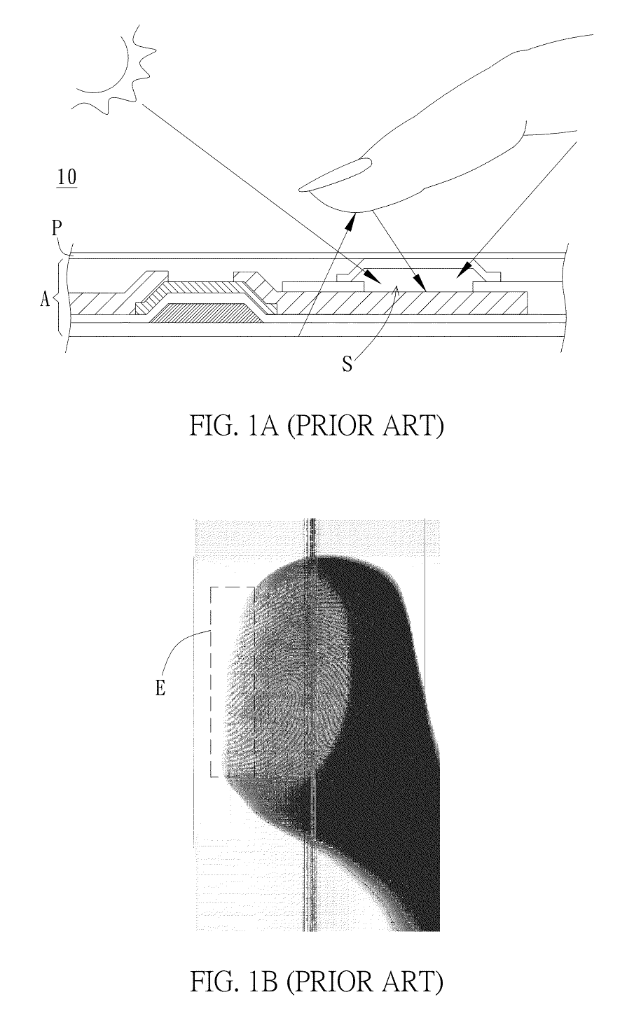

FIG. 2C is an example of a fingerprint scan performed by the optical device 100 of the present invention. Referring to FIGS. 2A-2C, in terms of the fingerprint scanning example, the control module 40 will generate a light-blocking pattern signal LBP according to the pre-scan image PI stored in the storage unit 43 after the control module 40 has received the scan instruction. The control module 40 will then transmit the light-blocking pattern signal LBP to the gate unit 41 to control the display of the light-filtering layer. Specifically, in an embodiment, the gate unit 41 drives the light-filtering layer 30 according to the light-blocking pattern signal LBP to actively and selectively allow or block external light in the pattern defined in the light-blocking pattern signal LBP. For instance, if the default mode of the light-filtering layer 30 is set to allow all light to pass through, the pre-scan image PI generated from data read-out-write-in unit 42 and stored in the storage unit 43 may be a white image. When the user places a finger on top of the optical device 100, the subsequent pre-scan image PI generated would be similar to the scan image of FIG. 1B. When the control module 40 receives the scan instruction, the control module 40 will generate the light-blocking pattern signal LBP according to the pre-scan image PI in the storage unit 43 and transmit the light-blocking pattern signal LBP to the gate unit 41 such that the light-filtering layer 30 actively and selectively blocks external light in the areas corresponding to the white areas around the black areas in the pre-scan image PI. In this manner, only light bouncing off the user's finger is allowed to pass through the light-filtering layer 30 to reach the sensor layer 20 and thereby generating the subsequent pre-scan image as a result scan image RI as exemplarily shown in FIG. 2C. In other words, the optical device 100 may provide scanning, unhindered by external light, of the finger to provide an accurate and detailed optical scan image (ex. fingerprint scan image).

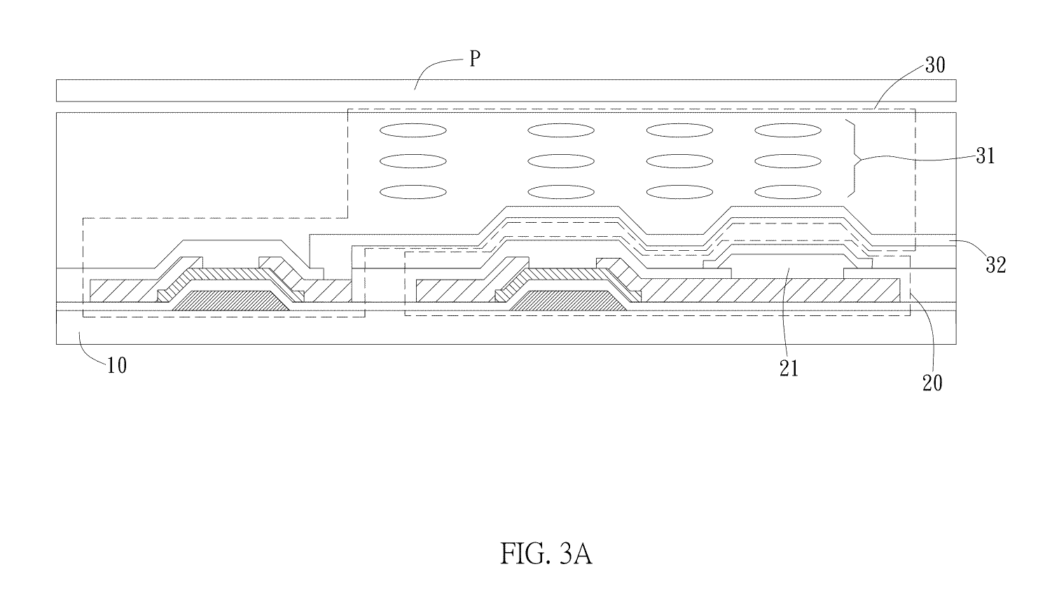

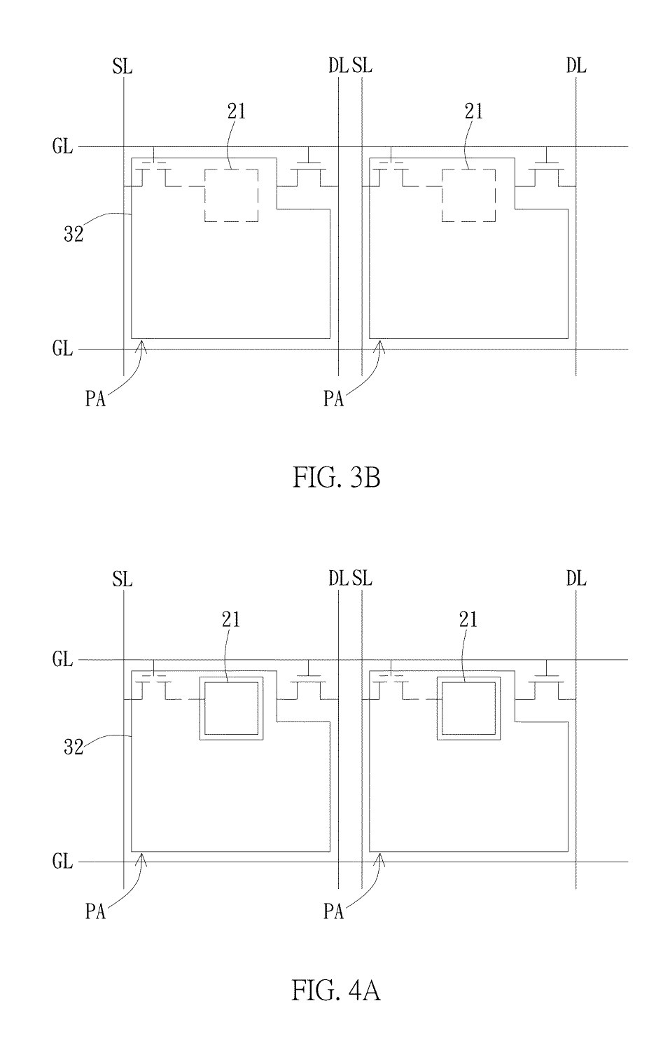

FIG. 3A is a cross-sectional view of the optical device 100 of FIG. 2A. As illustrated in FIG. 3A, the light-filtering layer 30 includes a liquid crystal layer 31 and a pixel electrode layer 32 beneath the liquid crystal layer 31. As shown in FIGS. 2A and 3A, in the present embodiment, the control module 40 generates the light-blocking pattern signal LBP according to the pre-scan image PI in the storage unit 43 and transmits the light-blocking pattern LBP to the pixel electrode layer 32 of the light-filtering layer 30 to control the filtering mechanism of the liquid crystal layer 31 of the light-filtering layer 30. In addition, the sensor layer 20 includes at least one sensor unit 21 such that the data read-out-write-in unit 42 can receive and generate the pre-scan image PI from the image signals produced by the at least one sensor unit 21. In the present embodiment, the sensor units 21 are implemented in the sensor layer 20 through thin-film transistors (TFT), wherein the sensor units 21 are light sensors to sense light passing through the light-filtering layer 30.

FIG. 3B is a circuit diagram of the embodiment shown in FIG. 3A. As shown in FIG. 3B, in the present embodiment, the sensor layer 20 has a plurality of sensor units 21. Referring to FIGS. 2 and 3A-3B, in the present embodiment, the pixel electrode 32 of the light-filtering layer 30 completely covers on top of the sensor unit 21 of the sensor layer 20. Each sensor unit 21 has a corresponding pixel electrode 32 such that the control module 40 can control whether external light may reach each pixel unit of the sensor unit 21 of the optical device 100. That is, in order to control whether or not external light may reach a particular sensor unit 21 in the sensor layer 20, each sensor unit 21 is associated with a pixel electrode layer 32 directly above the sensor unit 21 such that the liquid crystals in the liquid crystal layer 31 above may be controlled by the control module 40 through the associated pixel electrode layer 32.

In the present embodiment, the sensor layer 20 and the light-filtering layer 30 are coupled to the gate unit 41 that is associated with the control module 40, wherein the gate unit 41 has at least one gate line GL. As shown in FIGS. 2 and 3A-3B, in the present embodiment, the gate line GL corresponds to a row of the sensor units 21 and pixel electrodes 32 on the substrate 10. In other words, the gate unit 41 may have a plurality of gate lines GL, wherein each gate line GL corresponds to a different row of the sensor units 21 and pixel electrodes 32 on the substrate 10.

In addition, in the present embodiment, each of the plurality of sensor units 21 and the pixel electrodes 32 are respectively coupled to the data read-out-write-in unit 42 of the optical device 100 through a sensor read line SL and a data input line DL. In this manner, the data read-out-write-in unit 42 may receive the pre-scan image data from the sensor units 21 through the sensor read lines SL, while also being able to drive data signals corresponding to the scan instruction to the pixel electrodes 32. In order for the optical device 100 to be able to systematically control the receiving and driving actions of the sensor layer 20 and the light-filtering layer 30 in an orderly fashion, a timing unit (not shown) may be included in the control module 40 to activate the gate lines GL in sequential order such that the data read-out-write-in unit 42 can receive and transmit the pre-scan image from the sensor layer 20 to the control module 40 while driving the data (display/filtering) signals to the light-filtering layer.

As illustrated in FIG. 3B, in the present embodiment, a corresponding sensor unit 21 and pixel electrode 32 combination defines a pixel area PA. Preferably, the area between adjacent gate lines GL and between adjacent sensor read lines SL and data input lines DL having at least one of the sensor units 21 and the pixel electrodes 32 is defined as a pixel area PA. As such, in the present embodiment of FIG. 3B, the pixel electrode 32 in the pixel area PA overlaps the sensor unit 21 in the pixel area PA. In the present embodiment, as illustrated in FIG. 3B, the sensor unit 21 and the pixel electrode 32 of a particular pixel area PA are connected to a sensor read line SL and a data input line DL on opposite sides of the pixel area PA respectively. In other words, a pairing of data input line DL and sensor read line SL is disposed between two adjacent pixel areas PA on the same row corresponding to the same gate line GL. For instance, as illustrated in FIG. 3B, the sensor unit 21 of the left pixel area PA is connected to the sensor read line SL on its left side while the pixel electrode 32 of the same pixel area PA is connected to the data input line DL on the right side of the pixel area PA. In this manner, when the timing unit in the control module 40 activates the gate line GL, the sensor unit 21 will transmit image data to the read-out-write-in unit 42 through the sensor read line SL, while the pixel electrode 32 will be controlled by the data signal transmitted to it by the data read-out-write-in unit 42 through the data input line DL. In other different embodiments, the sensor read line SL and the data input line DL may be positioned on a same side of a particular pixel area, wherein the sensor unit(s) 21 and the pixel electrode(s) 32 of that particular pixel area may be connected to the sensor read line SL and the data input line DL positioned on the same side of the pixel area.

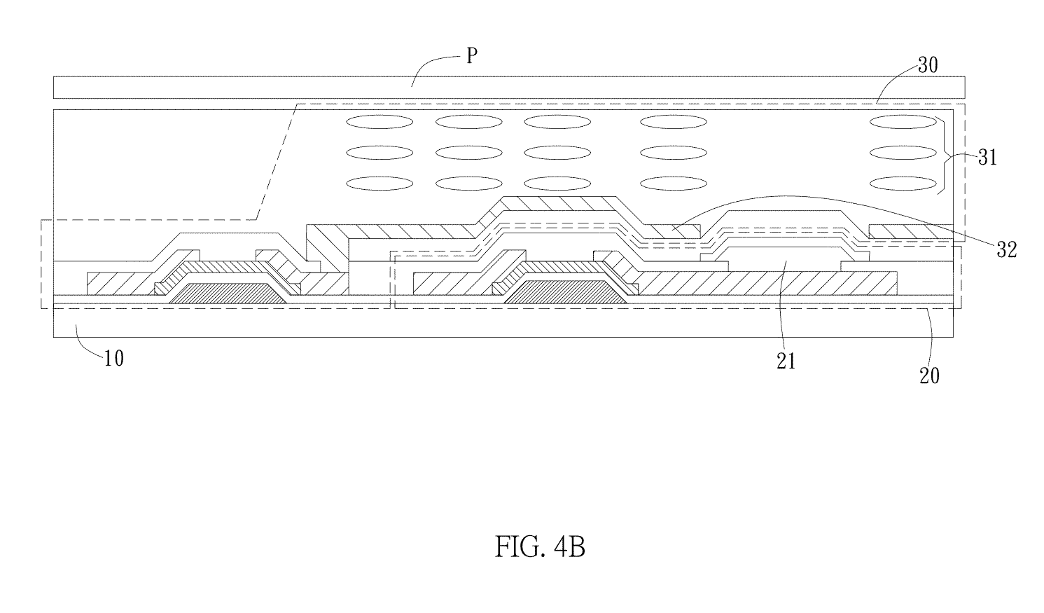

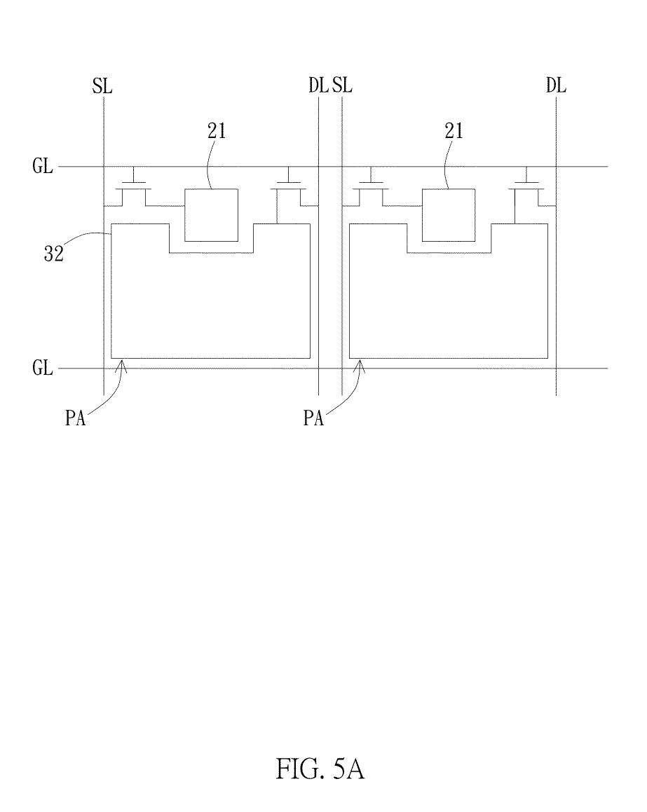

FIGS. 4A and 4B are another embodiment of FIGS. 3A and 3B. As illustrated in FIGS. 4A and 4B, the pixel electrode 32 of a particular pixel area PA may be hollowed out in a projection area of the sensor unit 21 of the same pixel area PA onto the pixel electrode 32 in the pixel area PA. In this manner, external light would not be obstructed by the pixel electrode 32 from reaching the sensor unit 21, thereby increasing the accuracy readings of the sensor unit 21.

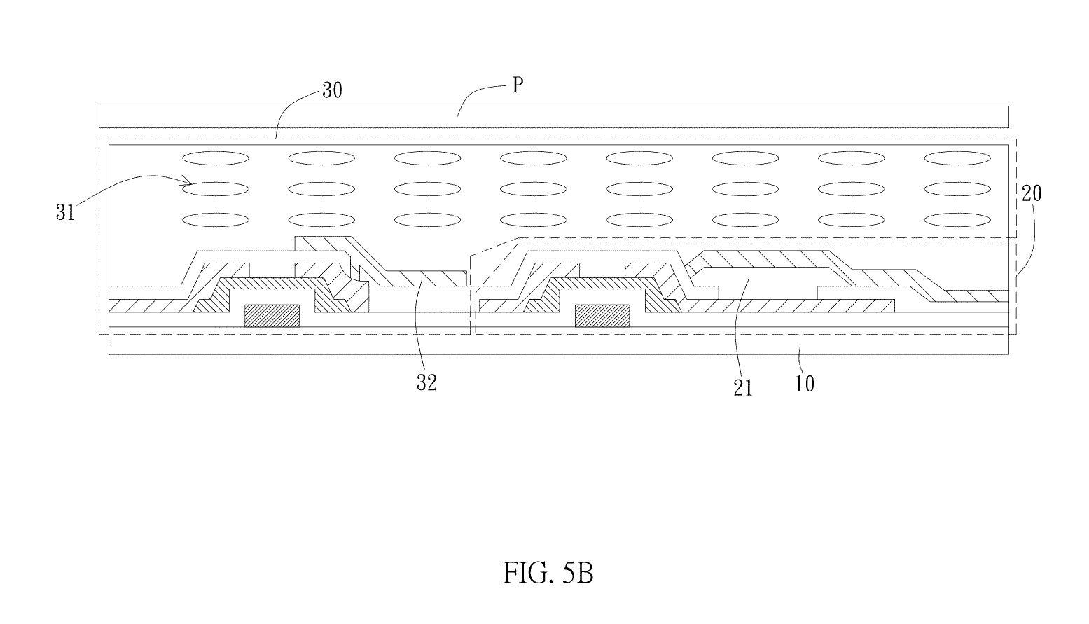

As shown in FIGS. 5A and 5B, FIGS. 5A and 5B illustrate another embodiment of FIGS. 4A and 4B. In the present embodiment, the sensor layer 20 and the light-filtering layer 30 are disposed adjacent to one another on the substrate 10, wherein a portion of the light-filtering layer 30 is still disposed above and over the sensor layer 20. However, similar to the previous embodiments of 3A-4B, the pixel area PA is defined by an area between adjacent gate lines GL and between adjacent sensor read lines SL and data input lines DL having at least one of the sensor units 21 and pixel electrodes 32. In addition, in the present embodiment, the pixel electrode 32 in the pixel area PA at least surrounds a portion of the sensor unit 21 in the pixel area PA. In other words, the pixel electrode 32 may at least partially surround the projection area of the sensor unit 21 onto the pixel electrode 32 in the pixel area PA as shown in FIG. 5A. In this manner, the stack height of the combination of the sensor layer 20 and the pixel electrode layer 32 on the substrate 10 may be decreased such that the overall stack height of the optical device 100 may be decreased.

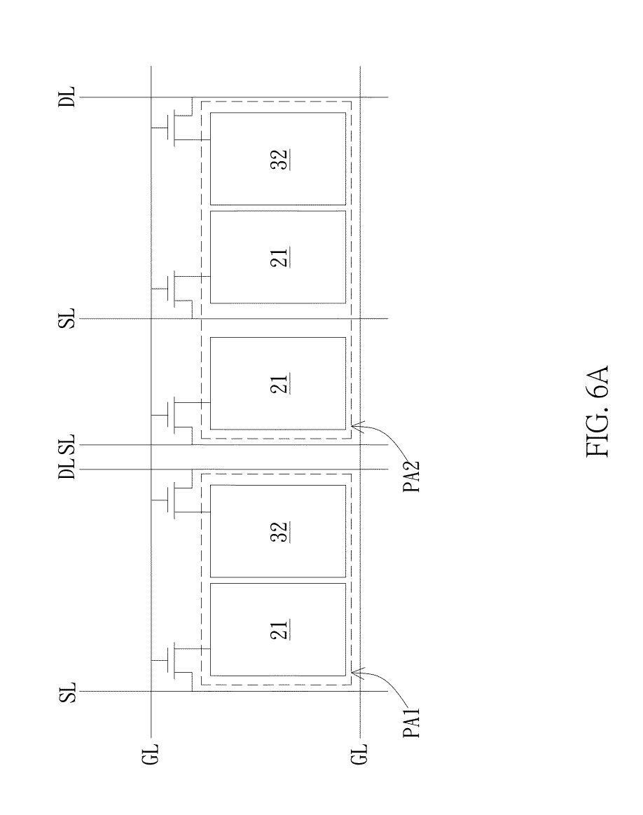

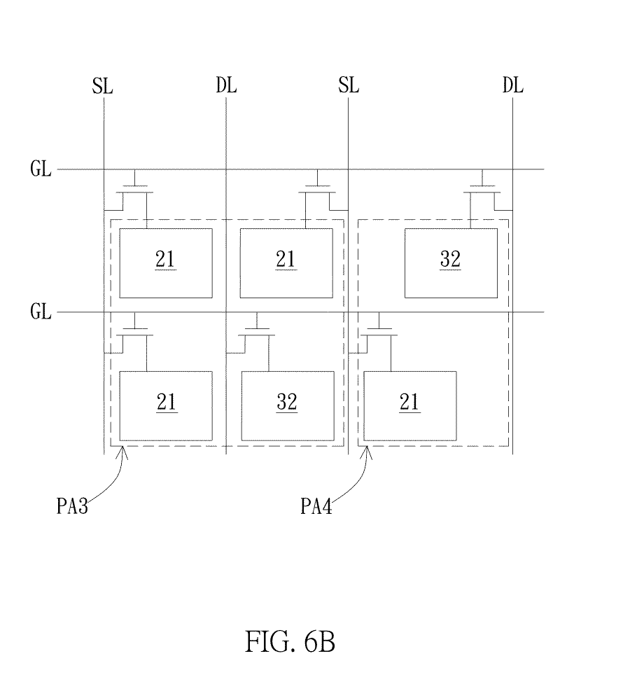

It should be noted that a pixel area PA is not restricted to only having a pair of one sensor unit 21 and one pixel electrode 32. In other different embodiments, a pixel area PA may have one pixel electrode 32 and a plurality of sensor units 21, a plurality of pixel electrodes 32 and one sensor unit 21, or a plurality of pixel electrodes 32 and a plurality of sensor units 21. For instance, as illustrated in FIG. 6A, a pixel area PA1 between an adjacent signal read line SL and data input line DL may have a single pairing of the sensor unit 21 and the pixel electrode 32. However, as seen in the pixel area PA2, there may be a plurality of sensor units 21 paired with a single pixel electrode 32. In the present embodiment, each of the sensor units 21 of the pixel area PA2 are connected respectively to their own signal read lines SL. Although in the pixel electrode 32 is placed to one side of the pair of the sensor units 21 in the pixel area PA2, in other different embodiments, the pixel electrode 32 may be disposed between the pair of the sensor units 21. In other words, no restrictions are placed on the arrangement of the sensor units and the pixel electrodes 32 in a pixel area PA. As an example, as shown in FIG. 6B, a pixel area PA3 may include a plurality of sensor units 21 surrounding a particular pixel electrode 32, wherein the pixel area PA3 spans between 3 adjacent gate lines GL. In the present embodiment, the sensor read lines SL and the data input lines DL are disposed in alternating order. In this manner, it should be noted that the sensor units 21 and the pixel electrode 32 of a particular pixel area are coupled respectively to the closest sensor read line SL and data input line DL.

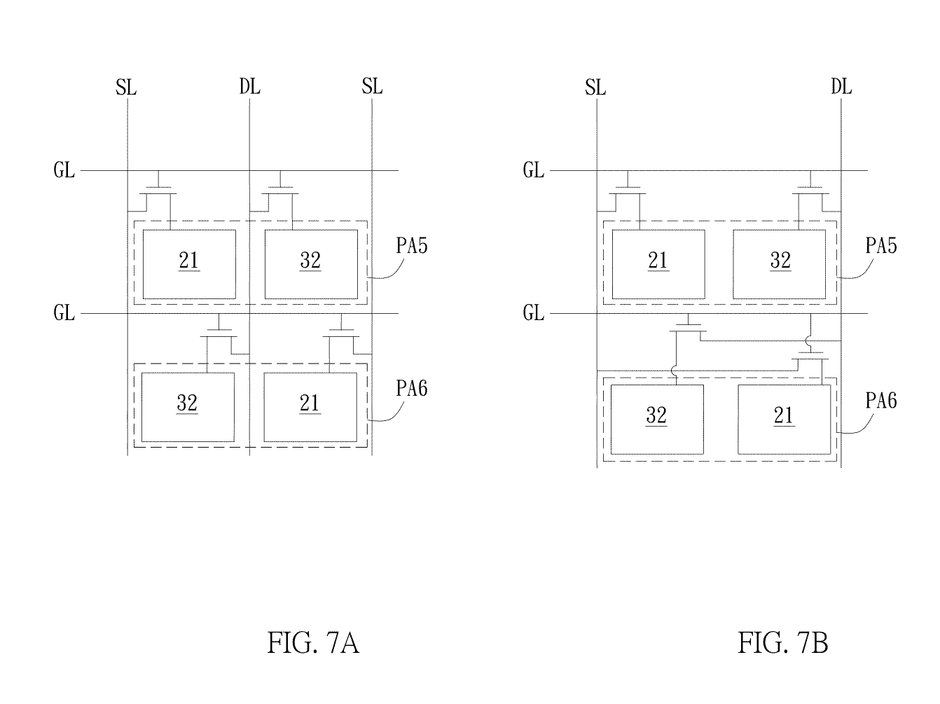

FIGS. 7A and 7B are another embodiment of the arrangement of sensor units 21 and pixel electrodes 32. As illustrated in FIG. 7A, sensor units 21 and pixel electrodes 32 may be disposed individually between adjacent pairings of sensor read lines SL and data input lines DL between adjacent gate lines GL. In the present embodiment, the sensor read lines SL and the data input lines DL are disposed in alternating order, wherein the pixel area is preferably defined as the pairing of adjacent sensor unit 21 and pixel electrode 32 on the same row corresponding to the same gate line GL, such as the pixel area PA5 and pixel area PA6. However, in other different embodiments, the pixel area may include the area defined by pixel area PA5 and the pixel area PA6 such that a 4×4 matrix structure between three gate lines GL forms the pixel area.

As shown in FIGS. 6B and 7A, in one aspect of the present invention, a pixel area may also be defined between two sensor read lines SL and has at least one of the sensor units 21 and pixel electrodes 32. In the present embodiment, the pixel area PA3 is between two sensor read lines SL and has 3 sensor units 21 surrounding one pixel electrode 32, whereas the pixel area PA5 and PA6 respectively are a pairing of one sensor unit 21 and one pixel electrode 32. As shown in FIGS. 6B and 7A, pixel areas may cut across multiple gate lines GL, or may be confined between adjacent gate lines GL.

FIG. 7B is another embodiment of FIG. 7A. As illustrated in FIG. 7B, the bottom pixel area PA6 has the sensor unit 21 and the pixel electrode 32 switched in comparison to the pixel area PA5. In the present embodiment, the circuit connecting the sensor unit 21 to the sensor read line SL interlaces with the circuit connecting the pixel electrode 32 to the data input line DL. In other words, in the present embodiment, a pairing of adjacent sensor unit 21 and pixel electrode 32 associated with one gate line GL (please see pixel area PA5 of FIG. 7B) is adjacent to a pairing of adjacent pixel electrode 32 and sensor unit 21 associated with an adjacent gate line GL (please see pixel area PA6 of FIG. 7B), wherein the circuits in one of the pairs connecting the sensor unit 21 and the pixel electrode 32 to the sensor read line SL and the data input line DL respectively are interlaced (see pixel area PA6). In this manner, Mura effect can be decreased while also allowing the pixel electrode 32 in the pixel area PA5 above the sensor unit 21 of pixel area PA6 to be driven.

In reference to FIGS. 6A-7B, it should be noted that the pixel electrode 32 in a pixel area may overlap the sensor units 21 of the same pixel area in similar fashion to the pixel electrodes 32 overlapping the sensor units 21 in FIGS. 3A-4B.

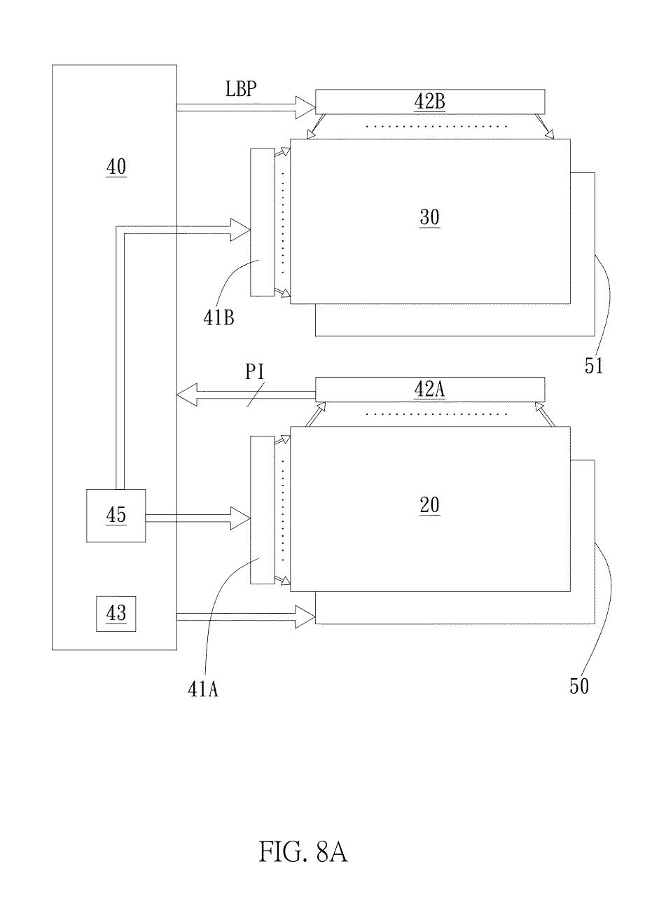

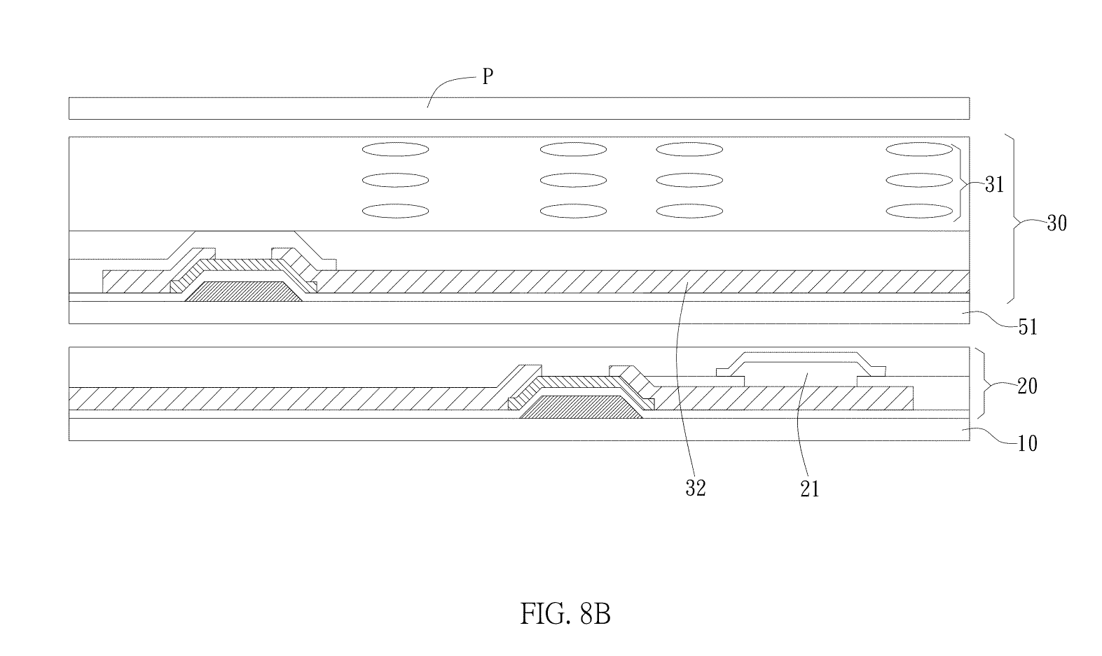

FIG. 8A is another embodiment of the optical device 100 of FIG. 2A. FIG. 8B is a cross-sectional view of the embodiment of FIG. 8A. As shown in FIGS. 8A and 8B, the sensor layer 20 and the light-filtering layer 30 may be respectively disposed on a substrate 50 and on a second substrate 51, wherein the light-filtering layer 30 is still disposed directly above the sensor layer 20. In other words, the light-filtering layer 30 includes the second substrate 51 positioned above the sensor layer 20 to carry the pixel electrode layer 32 and the liquid crystal layer 31. As illustrated in FIGS. 8A and 8B, the sensor layer 20 and the light-filtering layer 30 are respectively coupled to a first gate unit 41A and a second gate unit 41B in associated with the control module 40, wherein similar to the previous embodiments, the first gate unit 41A has at least one gate line GL where each gate line GL corresponds to a different row of the sensor units 21 while the second gate unit has at least one gate line GL where each gate line corresponds to a different row of the pixel electrodes 32. In the present embodiment, since the sensor layer 20 and the light-filtering layer 30 are on different substrates, the duties of the data read-out-write-in unit 42 of the embodiment in FIG. 2A have been split among a data readout unit 42A and a data write-in unit 42B. That is, the plurality of sensor units 21 in the sensor layer 20 and the plurality of pixel electrodes 32 in the light-filtering layer 30 are respectively coupled to the data readout unit 42A and the data write-in unit 42B in associated with the control module 40. Similar to the embodiment of FIG. 2A, each sensor unit 21 and pixel electrode 32 of the embodiment of FIG. 8A are coupled to the data readout unit 42A and the data write-in unit 42B respectively through sensor read lines and data input lines. In this manner, the control module 40 can receive the pre-scan image of the sensor units 21 and input data instructions to the pixel electrodes 32.

In addition, as illustrated in FIG. 8A, the control module preferably includes a timing unit for activating the gate lines in the sensor layer 20 in sequential order such that the data readout unit 42A receives and transmits the pre-scan image PI to the control module 40. In addition, the control module 40 of the embodiment in FIG. 8A may also include the storage unit 43 for storing the pre-scan image. In this manner, after the control module 40 receives the pre-scan image, the control module 40 may according to the pre-scan image generate and transmit the light-blocking pattern signal LBP to the data write-in unit 42B in order for the data write-in unit 42B to control the light-filtering layer 30 to selectively allow or block external light from reaching the sensor layer 20.

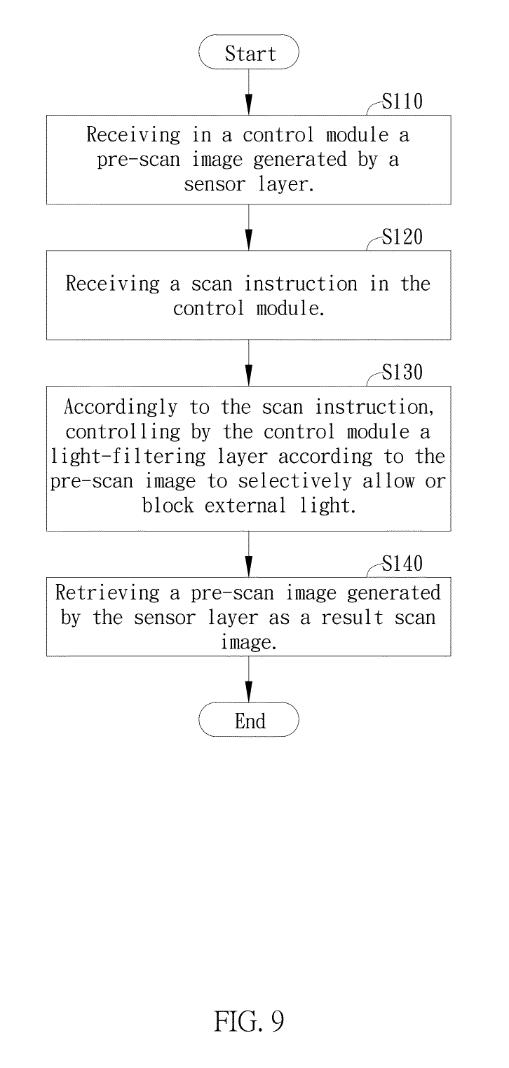

FIG. 9 is a flowchart of the optical scanning method for use in an optical device. In the present embodiment, the optical device is preferably the optical device shown in one of the above embodiments, wherein the optical device includes the sensor layer 20, the light-filtering layer 30, and the control module 40. As illustrated in FIG. 9, the optical scanning method includes steps S110, S120, S130, and S140.

Step S110 includes receiving in the control module a pre-scan image generated by a sensor layer. In the present embodiment, as shown in FIGS. 2A and 8A, the control module 40 receives the pre-scan image PI from the sensor layer 20 and then stores the pre-scan image in the storage unit 43. In an embodiment, as shown in FIGS. 2A and 2B, The control module 40 may then begin a prescan stage by transmitting a signal TS to the gate unit 41 to drive the sensor layer 20 in order for the sensor layer 20 to transmit the signals from the sensor units (signals forming the pre-scan image PI) to the data read-out-write-in unit 42. In this manner, the data read-out-write-in unit 42 can then subsequently transmit the pre-scan image PI to the control module 40, wherein the pre-scan stage may be repeated any number of times as required.

Step S120 includes receiving a scan instruction in the control module. In the present embodiment, after the control module 40 has received and stored the pre-scan image into the storage unit 43, the control module 40 may receive the scan instruction to perform image scanning. The scan instruction may be generated automatically according to the user touching the screen of the optical device 100 or may be generated from the user inputting the instruction through keypad buttons on the optical device 100.

Step S130 includes accordingly to the scan instruction, controlling by the control module the light-filtering layer according to the pre-scan image to selectively allow or block external light. In other words, after the control module 40 receives the scan instruction from the user, the control module 40 will retrieve the pre-scan image PI stored in the storage unit 43. The control module 40 will then control the light-filtering layer 30 according to the pre-scan image to selectively allow or block external light from reaching the sensor layer 20.

In the present embodiment, the sensor layer 20 and the light-filtering layer 30 may be disposed on the same substrate as exemplarily shown in the embodiment of FIG. 2. The control module 40 will receive the pre-scan image from the data read-out-write-in unit 42. Accordingly to the pre-scan image, the control module 40 will then generate the light-blocking pattern signal LBP according to the pre-scan image and then transmit the light-blocking pattern signal LBP to the data read-out-write-in unit 42 in order to control the light-filtering layer 30 through the data read-out-write-in unit 42 to selectively allow or block external light.

In other different embodiments, the sensor layer 20 and the light-filtering layer 30 may be disposed on separate substrates as exemplarily shown in the embodiment of FIGS. 8A and 8B. In the present embodiment, the control module 40 will receive the pre-scan image from the data readout unit 42A. Accordingly to the pre-scan image, the control module 40 will then generate the light-blocking pattern signal LBP according to the pre-scan image and then transmit the light-blocking pattern signal LBP to the data write-in unit 42B in order to control the light-filtering layer 30 through the data write-in unit 42B to selectively allow or block external light.

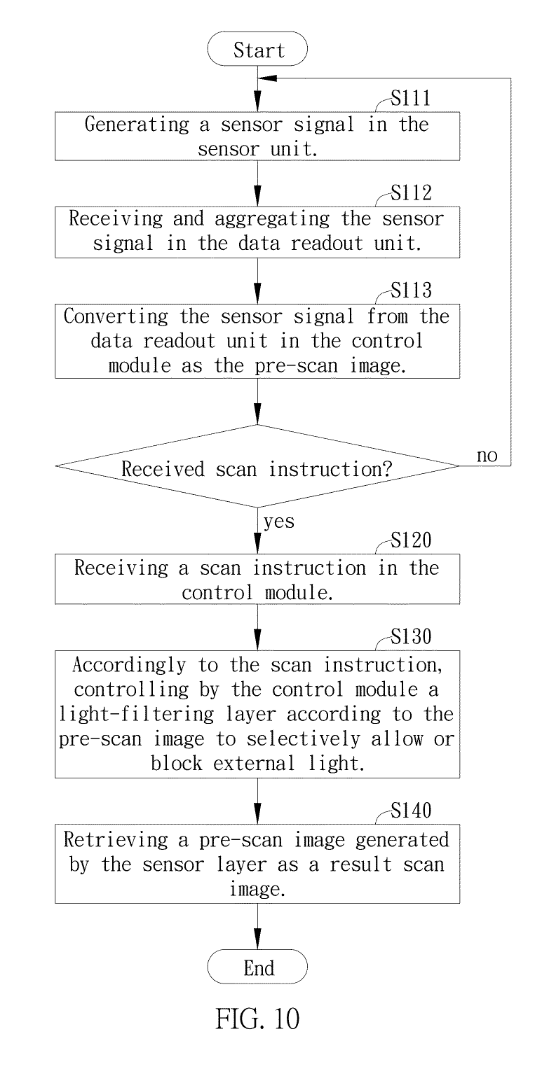

FIG. 10 illustrates the flowchart for generating the pre-scan image. As shown in FIG. 10, Step S110 of the FIG. 9 may further include steps S111, S112, and S113. Step S111 includes generating a sensor signal in the sensor unit. As shown in FIGS. 2A-8B, the sensor layer 20 includes at least one sensor unit 21, wherein the sensor unit 21 is coupled to the control module 40 through the data readout unit 42B or the data read-out-write-in unit 42. In the present embodiment, the sensor unit 21 is constantly generating the sensor signal according to the light it senses. Step S112 includes receiving and aggregating the sensor signal in the data readout unit. In the present embodiment, if there is a plurality of sensor units 21 in the sensor layer 20, the data readout unit 42B or the data read-out-write-in unit 42 will aggregate all the sensor signals it receives from the plurality of sensor units 21 in the sensor layer 20 and transmit the aggregated sensor signal to the control module 40. Step S113 includes converting the sensor signal from the data readout unit in the control module as the pre-scan image. In the present embodiment, the control module 40 will receive the aggregated sensor signal from the data readout unit 42B or the data read-out-write-in unit 42 and then convert the sensor signal into the pre-scan image.

As illustrated in FIG. 10, steps S111 to S113 may be repeated to constantly update the pre-scan image in the storage unit 43 until the control module 40 receives the scan instruction from the user. In the present embodiment, steps S111 to S113 are repeated constantly to persistently update the pre-scan image in the storage unit 43. In another embodiment, steps S111 to S113 may be repeated periodically according to a default time period to periodically update the pre-scan image in the storage unit 43 in order to conserve power comparatively to the previous embodiment.

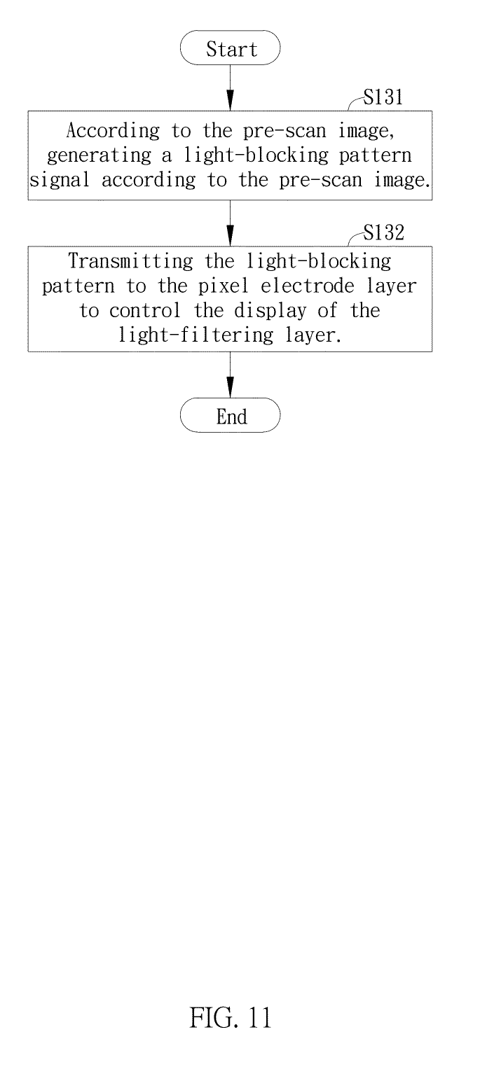

In addition, as illustrated in FIG. 11, Step S130 of the flowchart in FIG. 9 may further include steps S131 and S132. Step 131 includes according to the pre-scan image, generating a light-blocking pattern signal according to the pre-scan image. Step 132 includes transmitting the light-blocking pattern to the pixel electrode layer to control the display of the light-filtering layer. As shown in FIGS. 2A-8B, the control module 40 generates the light-blocking pattern signal LBP according to the pre-scan image in the storage unit 43 and then transmits the light-blocking pattern signal LBP to the data read-out-write-in unit 42 or data write-in unit 42B in order to control the selective allowing or blocking of external light in the light-filtering layer 30. In other words, the light-filtering layer 30 may selectively allow or block external light in a pattern according to the light-blocking pattern signal LBP.

After step S130, step S140 may be implemented, as illustrated in FIG. 10. Step S140 includes retrieving the pre-scan image generated by the sensor layer as a result scan image. Particularly, after the light-filtering layer 30 has been configured in step S120 to selectively allow or block external light in a pattern consistent with the light-blocking pattern signal LBP as described above, the optical device 100 may retrieve the subsequent pre-scan image generated by the sensor layer 20 as the result scan image RI as shown in FIG. 2B and previously explained. In another embodiment, step S110 as illustrated in FIG. 10 may once again be executed after Steps 110 to S130 have been executed in order to generate the pre-scan image as a result scan image RI. In other words, after the control module 40 has received the pre-scan image PI, step S110 (or steps S111 to 113) may be once again executed to generate the pre-scan image PI as the result scan image RI. In another different embodiment, the control module 40 may then optionally store the result scan image RI into the storage unit 43, and then control the light-filtering layer 30 based on a comparison conducted between the pre-scan image PI previously stored in the storage unit 43 with the result scan image RI.

Although the embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. An optical device, comprising:
a first substrate;
a sensor layer disposed on the first substrate, the sensor layer generating a pre-scan image;
a light-filtering layer disposed over the sensor layer, the light-filtering layer allows or blocks external light from reaching the sensor layer;
a control module coupled to the sensor layer and the light-filtering layer, wherein the control module controls the light-filtering layer according to the pre-scan image to selectively allow or block external light.

2. The optical device of claim 1, wherein the control module further includes a storage unit, the control module stores the pre-scan image in the storage unit, the control module controls the light-filtering layer according to the most recent pre-scan image in the storage unit to selectively allow or block external light after receiving a scan instruction.

3. The optical device of claim 1, wherein the light-filtering layer includes:
a liquid crystal layer;
a top substrate disposed over the liquid crystal layer; and
a pixel electrode layer beneath the liquid crystal layer;
wherein the control module generate a light-blocking pattern signal according to the pre-scan image and transmit the light-blocking pattern to the pixel electrode layer to control the display of the liquid crystal layer.

4. The optical device of claim 3, wherein the sensor layer has a plurality of the sensor units, the sensor layer and the light-filtering layer are coupled to a gate unit in associated with the control module, the gate unit has at least one gate line where each gate line corresponds to a different row of the sensor units and pixel electrodes on the first substrate.

5. The optical device of claim 4, wherein the plurality of sensor units and the plurality of pixel electrodes are respectively coupled to a data read-out-write-in unit in associated with the control module respectively through a sensor read line and a data input line to receive the pre-scan image of the sensor units and drive the data signal to the pixel electrodes.

6. The optical device of claim 5, wherein the control module includes a timing unit for activating the gate lines in sequential order such that the data read-out-write-in unit receives and transmits the pre-scan image from the sensor layer to the control module while driving the display signals to the light-filtering layer.

7. The optical device of claim 4, wherein an area between adjacent gate lines or between two sensor read lines having at least one of the sensor units and pixel electrodes define a pixel area, the pixel electrode in a pixel area overlaps the sensor unit in the pixel area.

8. The optical device of claim 4, wherein an area between adjacent gate lines and between adjacent sensor read lines and data input lines having at least one of the sensor units and pixel electrodes define a pixel area, the pixel electrode is hollowed out in a projection area of the sensor unit onto the pixel electrode in the pixel area or surrounds the projection area of the sensor unit onto the pixel electrode in the pixel area.

9. The optical device of claim 4, wherein on the substrate, a pairing of adjacent sensor unit and pixel electrode associated with one gate line is adjacent to a pairing of adjacent pixel electrode and sensor unit associated with an adjacent gate line; in one of the pairings, a circuit connecting the sensor unit to the sensor read line interlaces with a circuit connecting the pixel electrode to the data input line.

10. The optical device of claim 3, wherein the light-filtering layer further includes a second substrate positioned above the sensor layer for carrying the pixel electrode layer and the liquid crystal layer.

11. The optical device of claim 10, wherein the sensor layer and the light-filtering layer are respectively coupled to a first gate unit and a second gate unit in associated with the control module; the first gate unit has at least one gate line where each gate line corresponds to a different row of the sensor units while the second gate unit has at least one gate line where each gate line corresponds to a different row of the pixel electrodes.

12. The optical device of claim 11, wherein the plurality of sensor units and a plurality of pixel electrodes are respectively coupled to a data readout unit and a data write-in unit in associated with the control module respectively through a sensor read line and a data input line to receive the pre-scan image of the sensor units and input data signals to the pixel electrodes.

13. The optical device of claim 12, wherein the control module includes a timing unit for activating the gate lines in the sensor layer in sequential order such that the data read out unit receives and transmits the pre-scan image to the control module.

14. The optical device of claim 10, further comprising a third substrate disposed beneath the second substrate, wherein the third substrate sandwiches the sensor layer with the first substrate.

15. An optical scanning method for use in an optical device, wherein the optical device includes a sensor layer, a light-filtering layer disposed over the sensor layer, and a control module coupled to the sensor layer and the light-filtering layer, the method comprising:
(A) receiving in the control module a pre-scan image generated by the sensor layer;
(B) receiving a scan instruction in the control module; and
(C) Accordingly to the scan instruction, controlling by the control module the light-filtering layer according to the pre-scan image to selectively allow or block external light.

16. The method of claim 15, wherein the sensor layer includes at least one sensor unit respectively connected to a data readout unit, step (A) further comprises:
(a1) generating a sensor signal in the sensor unit;
(a2) receiving and aggregating the sensor signal in the data readout unit; and
(a3) converting the sensor signal from the data readout unit in the control module as the pre-scan image.

17. The method of claim 16, further comprises repeating steps (a1)-(a3) until the control module receives the scan instruction, step (C) includes controlling by the control module the light-filtering layer according to the most recent pre-scan image to selectively allow or block external light.

18. The method of claim 15, further comprising repeating step (A) after step (C) to generate the pre-scan image as a result scan image.

19. The optical scanning method of claim 15, wherein the step (C) further comprises:
(c1) according to the pre-scan image, generating a light-blocking pattern signal according to the pre-scan image; and
(c2) transmitting the light-blocking pattern signal to the pixel electrode layer to control the display of the light-filtering layer.
